(19) United States
(12) Patent Application Publication
(10) Pub. No.: US 2007/0062370 A1
(43) Pub. Date: Mar. 22, 2007

(54) Dehumidifier

(75) Inventors: Byung Yong Ahn, Changwon-si (KR); Seok Hun Kim, Busan (KR)

Correspondence Address: FLESHNER & KIM, LLP, P.O. BOX 221200, CHANTILLY, VA, 20153, US

(73) Assignee: LG Electronics Inc.

(21) Appl. No.: 11/450,300

(22) Filed: Jun. 12, 2006

(30) Foreign Application Priority Data
Jun. 13, 2005 (KR) P2005-0050274
Jun. 13, 2005 (KR) P2005-0050275

(51) Int. Cl. B01D 53/02; F25D 17/06

(52) U.S. Cl. 95/115; 62/93

(57) ABSTRACT

The present invention relates to a dehumidifier for improving dehumidifying efficiency and discharging dehumidified water to an outside of the dehumidifier easily. The dehumidifier includes a case, an inlet passed through the case for introduction of air from an outside of the case to an inside of the case, an outlet formed to pass through a top of the case for discharging air dehumidified in the case to the outside of the case, a desiccant assembly for absorbing moisture from air drawn into the case, a blower assembly for drawing air through the inlets and blowing the air to the outlet, a regenerator assembly for blowing hot air to the desiccant assembly for drying the desiccant assembly, a heat exchanger for condensing high temperature, humid air blown by the regenerator assembly through the desiccant assembly, to separate the moisture from the air, a top cover movably mounted on a top side of the case for opening/closing the top side of the case, and a water tank mounted beneath the top cover of the case at a top side thereof separable therefrom, for receiving, and holding water condensed at the heat exchanger.

### TECHNICAL FIELD

The present invention relates to dehumidifiers, and more particularly, to a dehumidifier, in which moisture is adsorbed, not by refrigerant, but by desiccant to collect the moisture separately, for improving dehumidifying efficiency.

### BACKGROUND ART

In general, the dehumidifier reduces humidity of a room by drawing humid air from the room, making the humid air to pass through a heat exchanger having a condenser and an evaporator through which refrigerant flows to remove moisture from the air, and discharging the air having the moisture removed therefrom, again.

That is, the dehumidifier takes heat from air around it by vaporizing liquid refrigerant at the evaporator. In more detail, a temperature of the evaporator drops as the refrigerant vaporizes, and as the air passes through the evaporator, a temperature of the air also drops.

As the temperature around the evaporator drops, the moisture in the air condenses, to form dew on a surface of the evaporator.

FIG. 1 illustrates a diagram of a related art dehumidifier.

Referring to FIG. 1, the related art dehumidifier is provided with a cabinet 1 having an inlet (not shown) for drawing room air, a filter 2 mounted on an inlet side, a heat exchanger 3 in front of the filter 2 on the cabinet 1 for heat exchange with the room air to dehumidify the room air, a fan assembly 4 in front of the heat exchanger 3 for forced circulation of the room air, a water tank 6 under the heat exchanger for collecting condensed water, and a front panel 5, a frontal exterior of the dehumidifier, having an outlet 5a.

However, the related art dehumidifier has the following problems.

The outlet 5a in the front panel 5 provides a poor outer appearance, and is difficult to change a direction of discharge of the air.

Since the water tank 6 can be mounted/dismounted through a rear of the cabinet 1, the mounting/dismounting of the water tank 6 is not convenient.

Because the room air passed through the heat exchanger 3 is discharged to the room again directly even if the moisture is not removed from the air fully, the dehumidifying efficiency is poor.

Moreover, the use of the compressor in the related art humidifier for circulation of the refrigerant leads a production cost high, and causes much noise and vibration during operation.

### DISCLOSURE

### Technical Problem

Accordingly, the present invention is directed to a dehumidifier that substantially obviates one or more problems due to limitations and disadvantages of the related art.

An object of the present invention is to provide a dehumidifier which has a high dehumidifying efficiency, low cost, and very low noise and vibration.

Another object of the present invention is to provide a dehumidifier which has a good outer appearance, and water tank for holding dehumidified water mounting/dismounting of which is easy.

### TECHNICAL SOLUTION

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, the dehumidifier includes a case, an inlet passed through the case for introduction of air from an outside of the case to an inside of the case, an outlet formed to pass through a top of the case for discharging air dehumidified in the case to the outside of the case, a desiccant assembly for absorbing moisture from air drawn into the case, a blower assembly for drawing air through the inlets and blowing the air to the outlet, a regenerator assembly for blowing hot air to the desiccant assembly for drying the desiccant assembly, a heat exchanger for condensing high temperature, humid air blown by the regenerator assembly through the desiccant assembly, to separate the moisture from the air, a top cover movably mounted on a top side of the case for opening/closing the top side of the case, and a water tank mounted beneath the top cover of the case at a top side thereof separable therefrom, for receiving, and holding water condensed at the heat exchanger.

### ADVANTAGEOUS EFFECTS

Thus, the dehumidifier of the present invention has the following advantages.

The absorption of moisture from room air and continuous dry of the absorbed moisture by a separate regenerator assembly improves dehumidifying efficiency compared to the related art dehumidifier.

The elimination of a compressor from the related art dehumidifier permits to reduce weight of the dehumidifier, as well as noise of the dehumidifier, to improve convenience of use of the dehumidifier.

Along with this, the easy mounting/dismounting of the water tank through the top side of the case improves convenience.

It is to be understood that both the foregoing general description and the following detailed description of the present invention are exemplary and explanatory and are intended to provide further explanation of the invention as claimed.

### DESCRIPTION OF DRAWINGS

The accompanying drawings, which are included to provide further understanding of the invention and are incorporated in and constitute a part of this application, illustrate embodiment(s) of the invention and together with the description serve to explain the principle of the invention. In the drawings;

FIG. 1 illustrates an exploded perspective view of a related art dehumidifier;

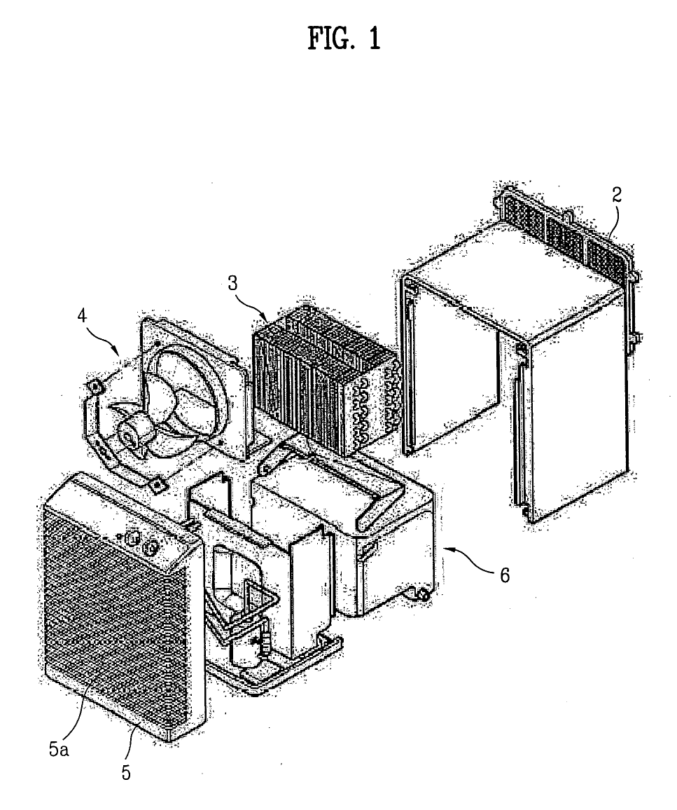

FIG. 2 illustrates a perspective view of a dehumidifier in accordance with a preferred embodiment of the present invention;

FIG. 3 illustrates a backside perspective view of the dehumidifier in FIG. 2;

FIG. 4 illustrates a perspective view showing a step for separating a water tank from the dehumidifier in FIG. 2;

FIG. 5 illustrates a detailed exploded perspective view of the dehumidifier in FIG. 2;

FIG. 6 illustrates a diagram showing a step for dehumidifying moisture from air by the dehumidifier in FIG. 2;

FIG. 7 illustrates a perspective view of a dehumidifier in accordance with another preferred embodiment of the present invention;

FIG. 8 illustrates a backside perspective view of the dehumidifier in FIG. 7;

FIG. 9 illustrates a perspective view of the dehumidifier in FIG. 7 with a front panel thereof opened;

FIG. 10 illustrates a perspective view showing a step for separating a water tank from the dehumidifier in FIG. 9;

FIG. 11 illustrates a detailed exploded perspective view of the dehumidifier in FIG. 7.

### BEST MODE

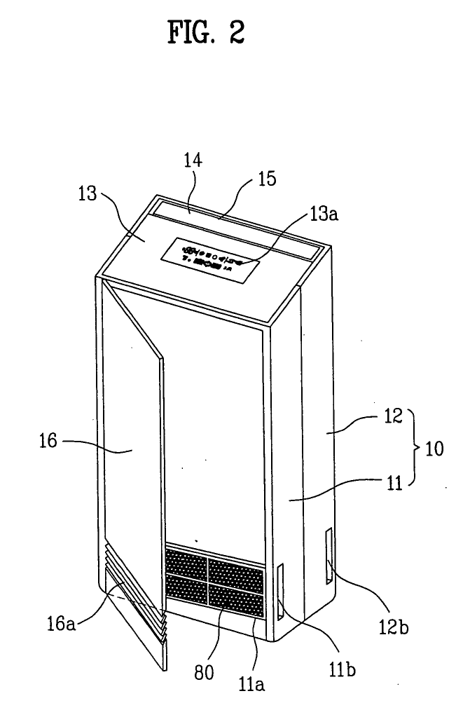

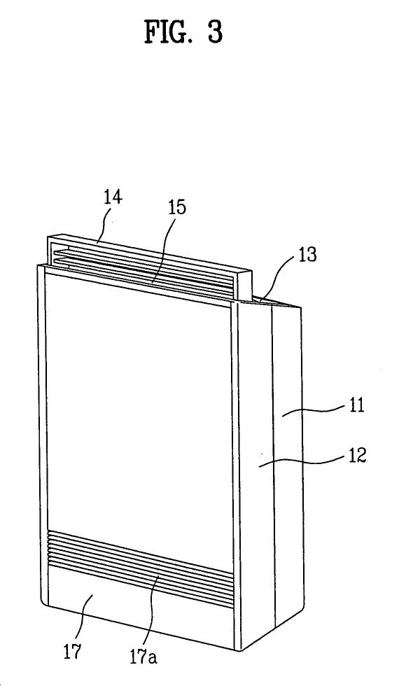

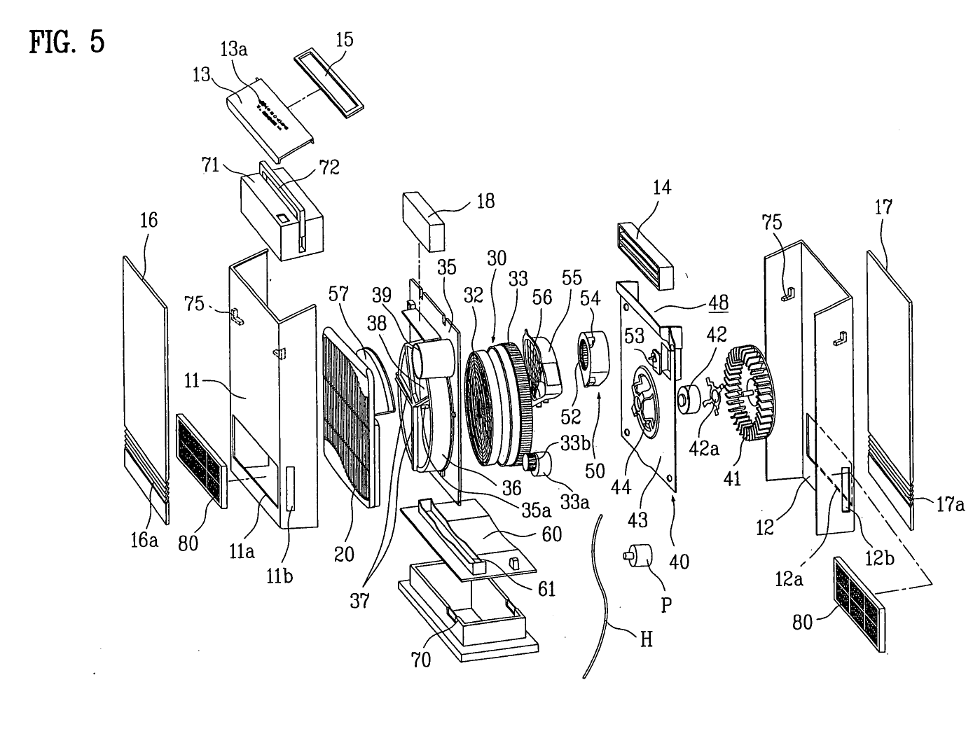

Reference will now be made in detail to the preferred embodiments of the present invention, examples of which are illustrated in the accompanying drawings FIGS. 2 to 6. Wherever possible, the same reference numbers will be used throughout the drawings to refer to the same or like parts.

Referring to FIGS. 2 to 5, the dehumidifier includes a case 10 of an exterior of the dehumidifier, a heat exchanger 20 of a heat conductive material in the case 10, a desiccant assembly 30 in the case 10 for absorbing moisture from the air, a blower assembly 40 for forcing the room air to be drawn into the case 10, and a regenerator assembly 50 for forced circulation of a portion of the room air drawn into the case 10 through the heat exchanger 20.

The case 10 has a hexahedral shape substantially, with a front half portion and a rear half portion. That is, the case 10 includes a front frame 11 forming exteriors of a front, sides and a top of a front half of the case 10, and a rear frame 12 forming exteriors of a rear, sides and a top of the rear half of the case 10. The front frame 11 and the rear frame 12 have hexahedral shapes having a rear and a front thereof opened, respectively.

The case 10 having the front frame 11 and the rear frame 12 has inlets 11a, and 12a in the front and the rear for drawing the room air. The inlets 11a, and 12a are in a front of the front frame 11 and in a rear of the rear frame 12, respectively.

The inlets 11a, and 12a are rectangular substantially, with filters 80 mounted thereon, respectively. The filter 80, for filtering foreign matters from air, may include a single unit selected from a prefilter for filtering relatively large sized dust from the air drawn through the inlets 11a, and 12a, deodoring filters for removing smell, dust collecting filters each for collecting dust by an electrical action, and a HEPA filter for removing fine dust, or an assembly having above various filters combined as one unit.

The filters 80 can be placed in, and taken out of the case 10 through filter openings 11b and 12b in one side of each of the front frame 11 and the rear frame 12, respectively.

In front of the front frame 11 having the inlet 11a, there is a front panel 16 for making a front exterior graceful. The front panel 16 has a shape of a rectangular plate with a size the same with the front frame 11. The front panel may be fixedly, or detachably secured to a side of the front frame 11, or has one side edge coupled to the front frame 11 with hinges enabling to rotate in a side direction.

In a lower side of the front panel 16, there is a front suction grill 16a with a size in correspondence to the inlet 11a in the front frame 11.

In rear of the rear frame 12 too, there may be a rear panel 17 for making a rear exterior graceful. The rear panel 17 has a shape of a rectangular plate with a size the same with the rear frame 12. The rear panel may also be fixedly, or detachably secured to the rear frame 12, or rotatably coupled to the rear frame 12.

In a lower side of the rear panel 17 too, there is a rear suction grill 17a with a size in correspondence to the inlet 12a in the rear frame 12.

At a top side of the case 10, there is a top cover 13 which is a top side of the case 10. The top cover 13 is sloped upward from a front side to a rear side. The top cover 13 has opposite sides hinged to opposite sides of a top side of the rear frame 12, to enable an up/down direction rotation to open/close a top side opening of the case 10.

At a center of the top cover 13 substantially, there is a display unit 13a for displaying an operation state of the dehumidifier. Though not shown, there may be a plurality of operation buttons on one side of the display unit 13a for operating the dehumidifier.

On a rear side of the top cover, there is an outlet 15 for discharging dehumidified air. Under the outlet 15, there is a discharge louver 14 for controlling a direction of air discharged through the outlet 15. Though not shown, the discharge louver 14 may be mounted to open/close the outlet 15 as the louver 14 slides up/down, or rotates in an up/down direction by a driving unit, such as a step motor and rack and pinion.

According to this, when the dehumidifier is not in operation, the discharge louver 14 slides down to a lower side of the outlet 15, to close the outlet 15, and when the dehumidifier is in operation, the discharge louver 14 slides up to open the outlet 15, to control a direction of the dehumidified air to be discharged to the room.

Under the top cover 13, there is a control box 18 electrically connected to the display unit 13a and the operation buttons for controlling the dehumidifier. Though not shown, in the control box 18, there are a plurality of components, such as circuit boards for controlling the operation of the dehumidifier on the whole.

Under the control box 18, there is a heat exchanger 20 for making heat exchange with the room air drawn through the inlet 11a. The heat exchanger 20 has two tiers of different sized heat exchangers having a plurality of metal tubes in communication with one another arranged at regular intervals for letting the air being introduced thereto, flows therethrough, and being discharged therefrom. At a bottom of the heat exchanger 20, there is a drain hole (not shown) for draining condensed water from the heat exchanger 20.

In rear of the heat exchanger 20, there is a regenerating cover 57 in correspondence to the heater case 55 to be described later. The regenerating cover 57 has an air pass through opening in a lower side for guiding the air circulated by the regenerator assembly 50 to the heat exchanger 20.

In rear of the regenerating cover 57, there is a desiccant assembly 30 for absorbing moisture from the room air drawn through the inlet 11a. The desiccant assembly 30 includes a desiccant member 32 for absorbing moisture from air, a rotor 33 for rotating the desiccant member 32, a rotor housing 35 for rotatably supporting the rotor 33, and a motor 33a for providing rotating power to the rotor 33.

The desiccant member 32 has a disk shape constructed of paper, with a plurality of pass through holes like a honeycomb. In more detail, the desiccant member 32 is fabricated by rolling two layers of paper like a honeycomb and bonding together, to form a plurality of the pass through holes, and permeating a desiccant solution therein.

According to this, when the room air passes through the pass through holes in the desiccant member 32, the moisture is absorbed in the desiccant member, to dry the air.

The desiccant member 32 has a disk shape and mounted to the rotor 33. The rotor 33 is a circular frame, and has a gear on an outside circumference. On an outer side of the rotor 33, there is a rotor driving gear 33b rotated by the rotor motor 33a. The rotor driving gear 33b is engaged with the outside circumference of the rotor 33, to rotate the rotor 33.

The rotor motor 33a rotates the rotor 33 slowly (for an example, 1 RPM) so that the desiccant member 32 absorbs moisture from the air passing therethrough.

The rotor 33 is housed in, and supported on the rotor housing 35. The rotor housing 35 has a square plate shape substantially, with an opened center. Around the opened center of the rotor housing 35, the rotor cover 36 is formed as a circular rim projected therefrom. In the rotor cover 36, the rotor 33 is housed.

At a center of the rotor cover 36, there is a rotation shaft 35a which is a rotation center of the rotor 33 supported by a plurality of supporting arms 37 extended from an edge of the rotor cover 36 to the center in a radial direction.

At an upper side of a right side of the rotor housing 35, there is a circulating duct 39 for guiding the air from the heat exchanger 20 to the regenerator assembly 50, and at a lower side of the right side of the rotor housing 35, there is the motor 33a coupled with the rotor driving gear 33b as one unit for providing rotating power to rotate the rotor 33.

In rear of the desiccant assembly 30, as a component of the regenerator assembly 50 to be described later, there is a heater 56 for providing heat to dry the desiccant member 32. The heater 56 has a fan shape substantially, and is encased in a heater case 55 having a front and a portion of a top opened.

Accordingly, since the heater case 55 is mounted matched to a fan shaped regenerative flow passage 38 partitioned at an upper side of the rotor housing 35 by the rotor arms 37, the heater case 55 serves to regenerate a portion of the desiccant member 32 to dry the portion, continuously.

In rear of the heater 56, there is the blower assembly 40 for drawing the room air through the inlet 11a, forcibly. The blower assembly 40 includes a fan 41 for drawing the room air through the inlet 11a, a blower housing 43 for housing, and supporting the fan 41, and a fan motor 42 for providing rotation power to the fan 41.

The blower housing 43 has a square plate shape substantially, with a circular opening at a center, to form a flow passage of the room air drawn by the rotation power of the fan 41. At a top of the blower housing 43, there is a discharge flow passage 48 for discharging the room air drawn by the fan 41 to an outside of the dehumidifier.

At the opened portion of the blower housing 43, there is a motor support 44 for housing a portion of the fan motor 42, and supporting the fan motor 42. Opposite to the motor support 44, there is a motor mount 42a for securing the fan motor 42.

In front of an upper side of the blower assembly 40, there is the regenerator assembly 50 for passing a portion of the room air drawn through the inlet 11a through the case 10.

The regenerator assembly 50 includes a regenerating fan 52, a regenerating fan housing 54 for housing and supporting the regenerating fan 52, a regenerating motor 53 for providing a rotating power to rotate the regenerating fan 52, a heater 56 for providing heat to dry the desiccant member 32, and a heater case 55 for casing the heater 56. The regenerating fan 52 may be a centrifugal type fan, such as a sirocco fan, but a variety of types of fans may be used.

The regenerating fan housing 54 has a disk shape substantially for mounting the regenerating fan 52 therein. The regenerating fan housing 54 has a suction opening at a center in communication with the circulating duct 39, and an outlet at one side of underside in communication with the heater case 55.

Therefore, when the regenerating fan 52 rotates, the air is drawn forcibly into the regenerating fan housing 54 through the circulating duct 39, and discharged to the heater case 55.

That is, the regenerating fan housing 54 guides the air from the regenerating fan 52 to the heater 56 and the regenerating flow passage 38, to keep drying a portion of the desiccant member 32 rotating at a position opposite thereto.

In the meantime, there is a drain pan 60 under the heat exchanger 20 for collecting condensed water from the heat exchanger 20 and guiding to a water tank 71. The drain pan 60 is rectangular substantially, with a drain groove projected upward for guiding condensed water from the heat exchanger 20 to the water tank 71.

Under the drain pan 60, there is a base pan 70 for fixedly coupling the front frame 11 and the rear frame 12 thereto and forming a bottom of the case 10. The base pan 70 has a hexahedral shape with closed sides except an opened top for holding water from the drain pan 60 at first.

On an upper side of the case 10, i.e., beneath the top cover 13, there is a water tank 71 mounted to enable to draw from an outside of the case 10 for receiving and holding water from the base pan 70. The water tank 71 has lower corners supported on four supporting projections 75 projected from insides of upper sides of the front frame 11 and the rear frame 12, respectively. It is preferable that the water tank 71 has a handle 72 for easy placing in, taking out of the water tank 71. It is also preferable that the water tank 71 has a float (not shown) mounted to be moveable in an up/down direction following a water level of water drained thereto for sensing full water. Though not shown, the float is connected to a sensor for give notice of the full water to an outside of the case through the display unit 13a.

In order to pump up the water held in the base pan 70 to the water tank 71, a pump P is mounted on the base pan 70, and a hose H is connected to the pump P and the water tank 71 for guiding the pumped water to the water tank 71. Of course, different from this, the hose H and the pump P may be connected to the heat exchanger 20 and the water tank 71 directly, for pumping the condensed water from the heat exchanger 20 to the water tank 71 directly without passing through the base pan 70.

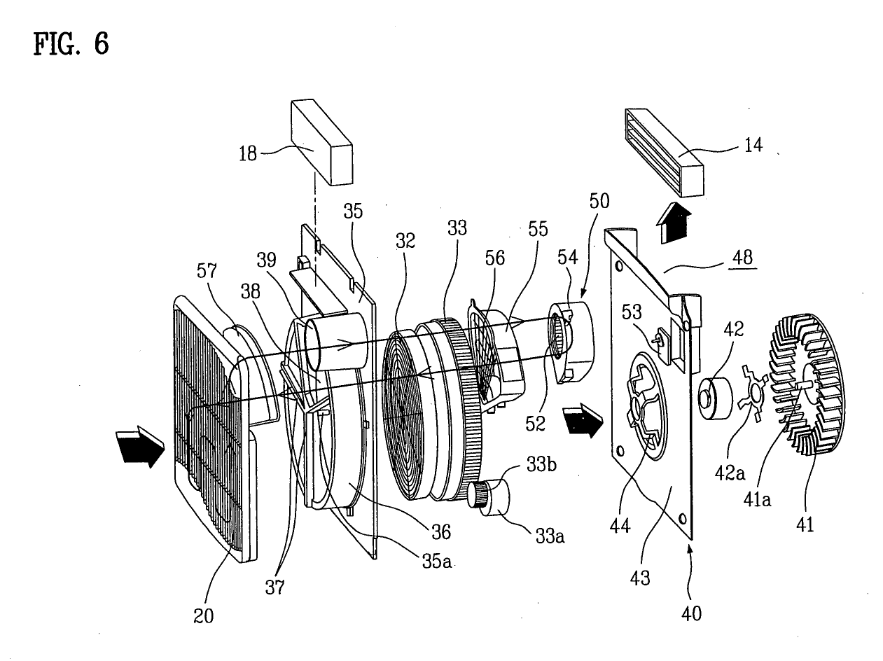

The operation of the dehumidifier of the present invention will be described in detail with reference to FIG. 6.

As indicated with large arrows, when humid room air is drawn into the case 10 through the inlets 11a, and 12a by the rotating power of the fan 41, the air has foreign matters removed therefrom as the air passes through the filter 80, and passes through the desiccant assembly 30 through the heat exchanger 20.

In this instance, the air has moisture removed therefrom as the air passes through the pass through holes in the desiccant member 32, and is discharged to the room through the outlet 15 by the rotating power of the fan 41 as the air passes through the blower assembly 40.

Next, as indicated with small arrows, in a regenerating process for drying the desiccant member 32 of the desiccant assembly 30 continuously, the air blown forcibly by the rotation of the regenerating fan 52 passes through the heater 60 through the heater case 55, and is heated to warm air such that the warm air evaporates moisture absorbed in the desiccant member 32.

The high temperature, humid air passed through the desiccant member 32 moves toward the heat exchanger 20 through the regenerating flow passage 38, and introduced into the regenerating cover 57. Then, the high temperature, humid air circulates through an inside of the heat exchanger 20, and has moisture therein condensed as the high temperature, humid air heat exchanges with the room air having a relatively low temperature drawn through the inlets 11a, and 12a in the circulating process. The condensed water is drained to the drain groove 61 through the drain hole 27 at the bottom of each of the heat exchangers, and collected in the base pan 70. Then, the water collected in the base pan 70 is pumped by the pump P to the water tank 71 guided along the hose H.

The air, having moisture removed therefrom as the air passes through the heat exchanger 20, repeats circulation in which the air is guided to the regenerating flow passage 38 through the circulating duct 39 of the rotor housing 35 again by the regenerating fan 52, to repeat the regenerating process of drying the desiccant member 32, continuously.

Thus, the dehumidifier of the present invention removes moisture from the room air by means of two streams of air flow. That is, the room air drawn by the fan 41 passes through, and has moisture therein absorbed at, the desiccant member 32, and is discharged to an outside of the dehumidifier through the outlet 13.

At the same time with this, while the dehumidifier makes the high temperature air to flow through the regenerative flow passage 38 by the regenerating fan 52, the dehumidifier separates the moisture from a portion of the desiccant member again and blows toward the heat exchanger 20, to condense, and remove the moisture from the air, at the heat exchanger 20, and circulates the air by the regenerating fan 52.

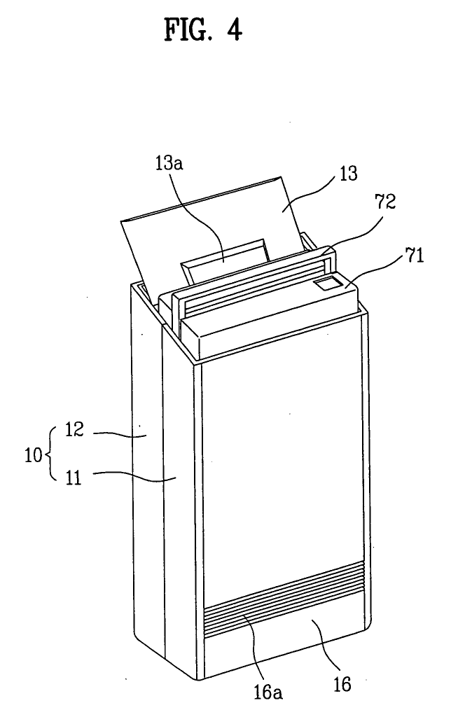

If the water tank 71 is full of water through above dehumidifying process for the float (not shown) to sense full water, the full water is informed to the user through the display unit 13a on the top cover 13. Then, as shown in FIG. 4, the user rotates the top cover 13, to open a top of the case 10, holds the handle 72 on the water tank 71, pulls up the water tank 71, and empties the water tank 71.

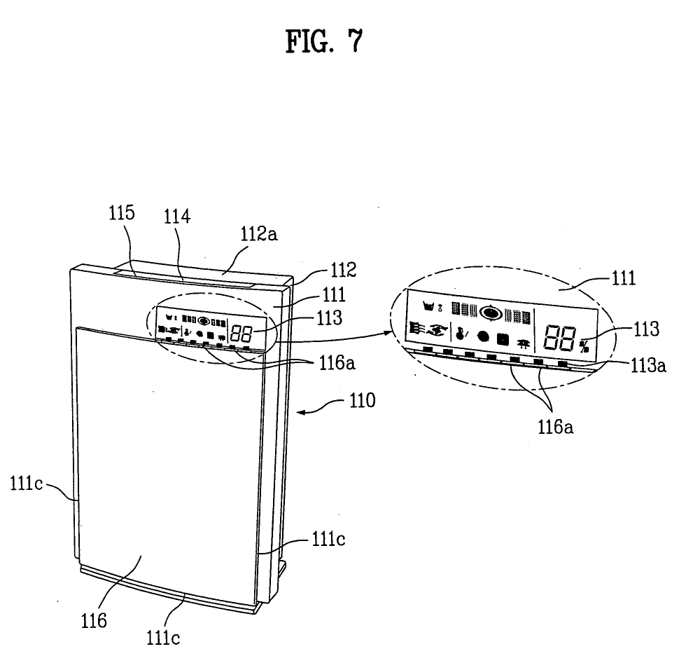

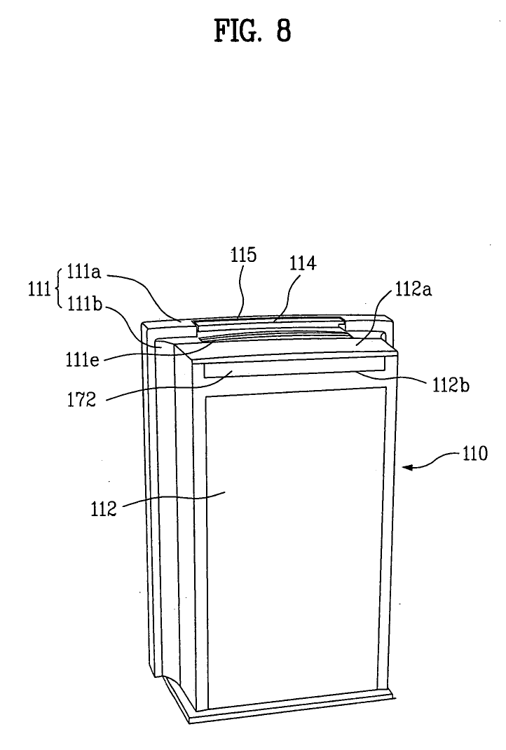

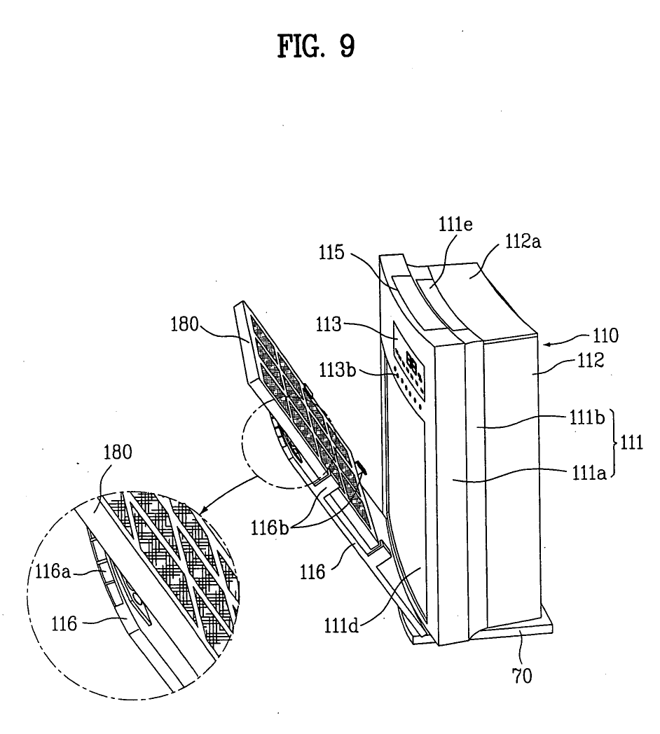

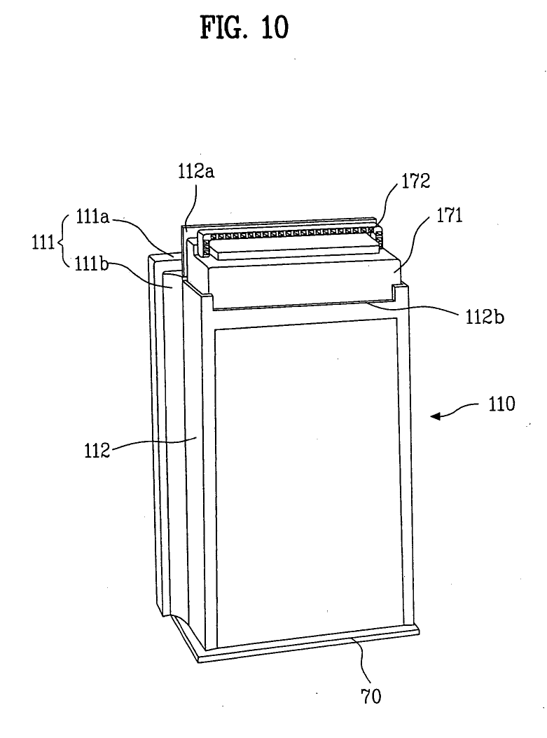

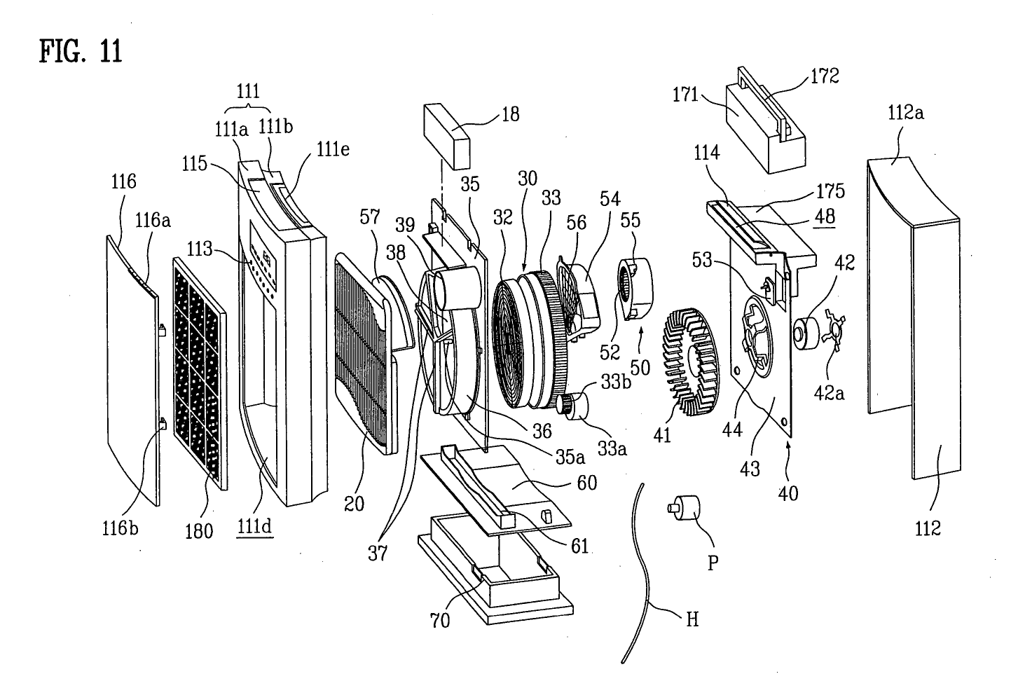

Next, a dehumidifier in accordance with another preferred embodiment of the present invention will be described with reference to FIGS. 7 to 11.

The dehumidifier of the embodiment includes a case 110, a heat exchanger 20, a desiccant assembly 30, a blower assembly 40, and a regenerator assembly 50. The heat exchanger 20, the desiccant assembly 30, the blower assembly 40, and the regenerator assembly 50 are identical to the foregoing embodiment, of which detailed description will be omitted.

The case 110 includes a front frame 111 of a box shape having a portion of a front and a rear opened, a rear frame 112 coupled to the rear of the front frame 111 having an opened front, and a base pan 70 which is a bottom of the case 110 for fixedly securing the front frame 111 and the rear frame 112.

The front frame 111 has a front portion 11a and a rear portion 111b, with the front portion 112 formed slightly larger than the rear portion 111b. That is, the front portion 111a has a step backwardly such that the front portion 111a has a height and a width slightly greater than the rear portion 111b, and the rear portion 111b is formed in correspondence to a size of the rear frame 112. The front frame 111 has an opening 111d in the front portion 111a for drawing room air.

The front portion 111a of the front frame 111 formed larger than the rear portion 111b, not only provides a sense of beauty better than a simple hexahedral shape, but also enables to form a larger opening 111d, to increase a suction air flow rate.

On one side of an upper side of the front portion 111a, there is a display unit 113 for displaying an operation state of the dehumidifier. Under the display unit 113, there are a plurality of LED windows 113a provided thereto, for displaying operation of operation buttons 113b. Upon pressing the operation buttons 113b, the LED windows 113a indicate whether the operation buttons 113b are pressed or not. The operation buttons 113b are covered with an upper side of the front panel 116.

The front frame 111 has an opening 111d in the front portion 11a for drawing room air. In front of the front portion 111a, the front panel 116 is mounted to be rotatable in an up/down direction. The front panel 116 has a rectangular plate shape with a size corresponding to the opening 111d.

On a right side of a top of the front panel 116, there are push buttons 116a for operating the operation buttons 113b from an outside of the front panel 116. Therefore, if the push buttons 113b are pressed, the pressing of the push buttons 113b is displayed on the LED windows 113a, and operation of the dehumidifier is controlled while a desired function is displayed on the display unit 113.

When the front panel 116 is closed, the front panel 116 is spaced a predetermined distance away from the front portion of the front frame 111 between opposite sides and tops and bottoms of the front panel 116 and the front portion 111a of the front frame 111, to form an inlet 111c for drawing air therethrough.

On a backside of the front panel 116, there is a filter 180 for filtering foreign matters from the air introduced thereto. The filter 180 is slidably supported on a plurality of filter guides 116b at opposite sides of the front panel 116 to slide in an up/down direction. The filter 180 is arranged to maintain a gap from a backside of the front panel 116 when the filter 180 is mounted on the filter guide 116b for leading the air introduced through the inlet 111c at opposite sides thereof to pass the filter 180, and to be introduced into the dehumidifier through the opening 111d.

In the meantime, substantially at a center of a top side of the front portion 111a of the front frame 111, there is a rectangular outlet 115 extended in a lateral direction. The outlet 115 guides the air drawn through the inlet 111c and dehumidified in the case 110 to be discharged to the room again. The outlet 115 is opened/closed by a discharge louver 114 mounted thereon to be rotatable in an up/down direction.

Accordingly, upon putting the dehumidifier into operation, the discharge louver 114 rotates upward to open the outlet 115, and upon stopping the dehumidifier, the discharge louver 114 rotates downward, to close the outlet 115, infiltration of foreign matters into the case 110 is prevented.

On a top of the rear portion 111b of the front frame 111, there is a dehumidifier handle 111e for easy movement of the dehumidifier. The dehumidifier handle 111e is placed in a dehumidifier groove (not shown), and may be of an one-touch type which makes the handle 111e to be moved upward or downward to expose the handle 111e only with a simple pressing action of the user.

There is a top cover 112a rotatably mounted on a top side of the rear frame 112. Beneath the top cover 112a, there is a water tank 171 for receiving and holding water from the base pan 70. The water tank 171 is seated, and supported on a water tank support 175 fixedly secured to an upper side of the blower housing 43 of the blower assembly 40. The water tank 171 has a handle 172 rotatably mounted thereon.

The rear frame 112 has a top portion cut away to form a handle recess 112b for receiving the handle 172 of the water tank 171. Therefore, if the water tank 171 is placed in the case 110, and the handle 172 is put backward, the handle 172 is placed in the handle recess 112b, to close the handle slot 112b, completely. It is preferable that the handle 172 is flush with an outside surface of the rear frame 112.

Accordingly, if the user lifts the top cover 112a upward to open the top of the rear frame 112, and holds the handle 172 and lifts the water tank 171 upward, the water tank 171 is separated from the case 110, easily.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A dehumidifier comprising:
a case;
an inlet passed through the case for introduction of air from an outside of the case to an inside of the case;
an outlet formed to pass through a top of the case for discharging air dehumidified in the case to the outside of the case;
a desiccant assembly for absorbing moisture from air drawn into the case;
a blower assembly for drawing air through the inlets and blowing the air to the outlet;
a regenerator assembly for blowing hot air to the desiccant assembly for drying the desiccant assembly;
a heat exchanger for condensing high temperature, humid air blown by the regenerator assembly through the desiccant assembly, to separate the moisture from the air;
a top cover movably mounted on a top side of the case for opening/closing the top side of the case; and
a water tank mounted beneath the top cover of the case at a top side thereof separable therefrom, for receiving, and holding water condensed at the heat exchanger.

2. The dehumidifier as claimed in claim 1, further comprising:
a base pan for collecting water condensed at the heat exchanger at first; and
a pumping unit for supplying water from the base pan to the water tank.

3. The dehumidifier as claimed in claim 1, further comprising:
a display unit on the top cover for displaying an operation state of the dehumidifier; and
operation buttons for putting in an operation order to the dehumidifier from an outside of the dehumidifier.

4. The dehumidifier as claimed in claim 1, wherein the case includes a plurality of supporting projections at an upper side of an inside of the case for supporting a bottom of the water tank.

5. The dehumidifier as claimed in claim 1, wherein the blower assembly includes a support at an upper side for supporting a bottom of the water tank.

6. The dehumidifier as claimed in claim 1, wherein the desiccant assembly includes;
a desiccant member for absorbing moisture from air,
a desiccant rotor rotatably mounted for housing the desiccant member,
a desiccant rotor housing for rotatably supporting the desiccant rotor, and
a rotating unit for rotating the desiccant rotor.

7. The dehumidifier as claimed in claim 6, wherein the rotating unit includes;
a gear formed along an outside circumference of the desiccant rotor,
a rotor driving gear engaged with the gear, and
a rotor motor for providing a rotating power to rotate the rotor driving gear.

8. The dehumidifier as claimed in claim 1, wherein the blower assembly includes;
a fan for generating a suction power for drawing air,
a blower housing for housing and supporting the fan, and
a fan motor mounted on the blower housing for rotating the fan.

9. The dehumidifier as claimed in claim 1, wherein the regenerator assembly includes;
a regenerating fan for blowing air toward the desiccant assembly,
a regenerating fan housing for housing the regenerating fan,
a regenerating motor for providing a rotating power to rotate the regenerating fan,
a heater for heating the air blown by the regenerating fan,
a heater case for casing the heater, having one side in communication with the regenerating fan housing, and the other side in communication with a portion of the desiccant assembly for guiding air from the regenerating fan to the desiccant assembly,
a regenerating cover for guiding the air passed through the desiccant assembly by the regenerating fan to an inside of the heat exchanger, and
a circulating duct for guiding the air passed through the heat exchanger to the regenerating fan.

10. The dehumidifier as claimed in claim 1, further comprising a front panel detachably mounted to a front of the case.

11. The dehumidifier as claimed in claim 1, further comprising a rear panel detachably mounted to a rear of the case.

12. The dehumidifier as claimed in claim 1, wherein the case includes;
a front frame of a box shape with an opened rear, and
a rear frame of a box shape coupled to the rear of the front frame.

13. The dehumidifier as claimed in claim 12, further comprising a display unit for displaying an operation state of the dehumidifier and operation buttons for inputting operation orders to the dehumidifier, provided to a top side of the front frame.

14. The dehumidifier as claimed in claim 12, wherein the front frame includes an inlet for drawing room air, the front panel is provided in front of the front frame for hiding the opening, with a predetermined gap between the front panel and the front frame to provide an inlet for drawing air.

15. The dehumidifier as claimed in claim 14, further comprising a filter detachably mounted to a backside of the front panel for filtering foreign matters from the air introduced through the inlet.

16. The dehumidifier as claimed in claim 14, further comprising a display unit for displaying an operation state of the dehumidifier and operation buttons for inputting operation orders to the dehumidifier, provided to a top side of the front frame, and push buttons on a top of the front panel for pressing the operation buttons as the user pushes the push button.

17. The dehumidifier as claimed in claim 1, wherein the water tank includes a handle formed thereon.

18. The dehumidifier as claimed in claim 17, wherein the rear portion of the case has a top portion cut away to form a handle recess for receiving the handle of the water tank, to expose the handle to an outside of the case when the handle is placed in the handle recess.

19. The dehumidifier as claimed in claim 1, further comprising a discharge louver movably mounted at one side of the outlet for opening/closing the outlet.
